(19) United States
(12) Patent Application Publication
(10) Pub. No.: US 2019/0058837 A1
(43) Pub. Date: Feb. 21, 2019

(54) SYSTEM FOR CAPTURING SCENE AND NIR RELIGHTING EFFECTS IN MOVIE POSTPRODUCTION TRANSMISSION

(71) Applicant: IRVI Pte. Ltd., Tanglin Place (SG)

(72) Inventor: Jan Cerny, Prague (CZ)

(21) Appl. No.: 16/054,059

(22) Filed: Aug. 3, 2018

Related U.S. Application Data
(63) Continuation of application No. 14/434,199, filed on Apr. 8, 2015.

(30) Foreign Application Priority Data
Oct. 9, 2012 (IN) 4207/CHE/2012

(51) Int. Cl. H04N 5/33; H04N 5/225; H04N 5/275

(52) U.S. Cl. CPC H04N 5/332; H04N 5/275; H04N 5/2256; H04N 5/2258

(57) ABSTRACT

A system for capturing a scene with a simultaneous use of an IR light and a VIS light to create at least one of an alpha channel mask or a relighting effect in a movie post-production transmission. The system includes a lighting system that includes an NIR light source and a VIS light source. The system also includes an electro-optical system configured to simultaneously acquire a video in a NIR spectrum and in a VIS spectrum based on the NIR light source and the VIS light source. The system further includes a post-processing converter configured to generate an alpha channel mask from the video based on the NIR spectrum to distinguish between a foreground object and a background over which the foreground object is positioned. The foreground object is illuminated via the NIR light source.

### CROSS REFERENCE TO RELATED APPLICATIONS

The present application is a Continuation of U.S. National Phase application Ser. No. 14/434,199 filed 8 Apr. 2015; which claims a benefit of priority to PCT International Application Number PCT/IB13/02233 filed 8 Oct. 2013; which claims a benefit of India Application No. 4207/CHE/2012 filed 9 Oct. 2012; each of which is fully incorporated herein by reference in its entirety for all purposes.

### FIELD OF INVENTION

The invention in general relates to the hardware and software solution for postproduction effects.

In particular the invention relates to the system for capturing scene with the simultaneous use of visible and infrared light for alpha channel creation and relighting effects in movie postproduction.

### BACKGROUND OF INVENTION

Chroma key compositing or chroma keying, is a special effects/post-production technique for compositing (layering) two images or video streams together based on color hues (chroma range). The technique has been used in many fields to remove a background from the subject of a photo or video—particularly the newscasting, motion picture and videogame industries.

The chroma keying technology relies on image manipulation. Information about the foreground object and color range to be removed is recorded within a single video layer.

One of the main draw back of the chroma keying technology is that in the process of the color range removal, semi transparent areas and fine details along the edges of the foreground objects are lost. In order to control the same in present chroma keying technology, the chroma keying workflow has been updated by some software solutions (,such as Autodesk Flame, Adobe Alftereffects, etc.) and development of the greenscreen/bluescreen surfaces—more precise algorithms for color range removals and development of special fabrics.

Apart from the above draw back, the chroma keying technology requires large uniform surfaces (greenscreen/bluescreen) to create a sufficient chroma difference between foreground and background.

Hence it is required to address the long felt need of providing system for highly automated and precise derivation of alpha channel in order to divide the captured scene into the foreground objects and background.

### SUMMARY OF THE INVENTION

A system for capturing scene with the simultaneous use IR and VIS light for alpha channel creation and relighting effects in movie postproduction transmission comprising the subsystems of:

Lighting sub system,

Electro-optical system for simultaneous acquisition of the video in VIS and NIR, and

Video post-processing converter for generation of alpha channel from the NIR video signal to perform determination between the foreground objects, illuminated with NIR light source and background. Video post-processing converter uses VIS images to obtain information for more precise alpha channel derivation.

These and other objects, features and advantages of the present invention will become more apparent from the ensuing detailed description of the invention taken in conjunction with the accompanying drawings.

### DESCRIPTION OF DRAWINGS

The present invention will be understood and appreciated more fully from the following detailed description taken in conjunction with the appended drawings in which:

FIG. 1A illustrates a schematic diagram of the invention wherein

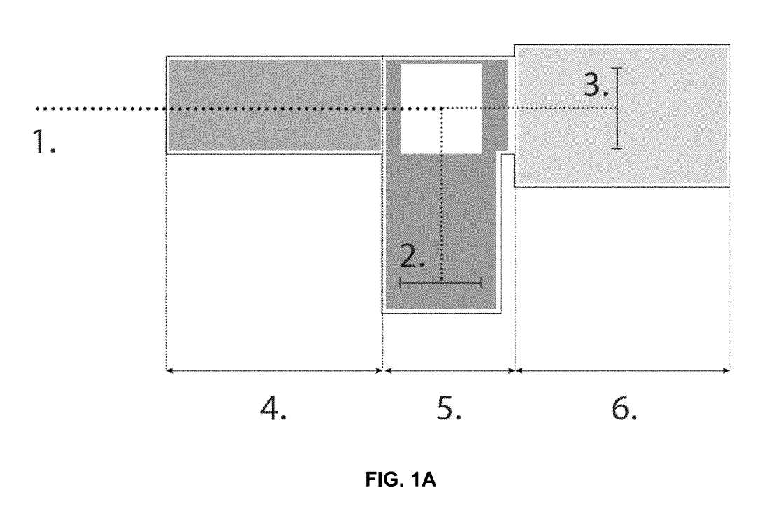

1. Light

2. Image sensor sensitive to IR

3. Image sensor sensitive to VIS

4. Lens

5. Infrared video acquisition unit

6. VIS Camera

FIG. 1B illustrates the details of optical drivers, wherein

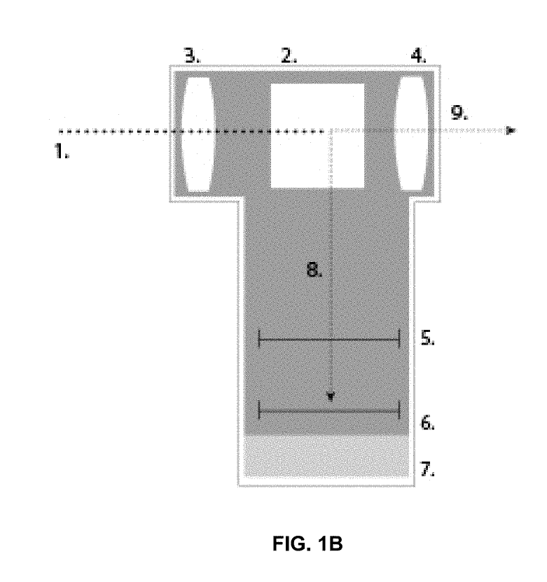

1. Light

2. Color splitting system (eg. prism, mirror)

3. Relay optics (optical system to keep the focal length of lens)

4. Relay optics (optical system to keep the focal length of lens)

5. Bandpass interference filter

6. Image sensor sensitive to IR light

7. Software processing unit/output module

8. IR

9. VIS

FIG. 2A illustrates a schematic diagram of the invention, wherein

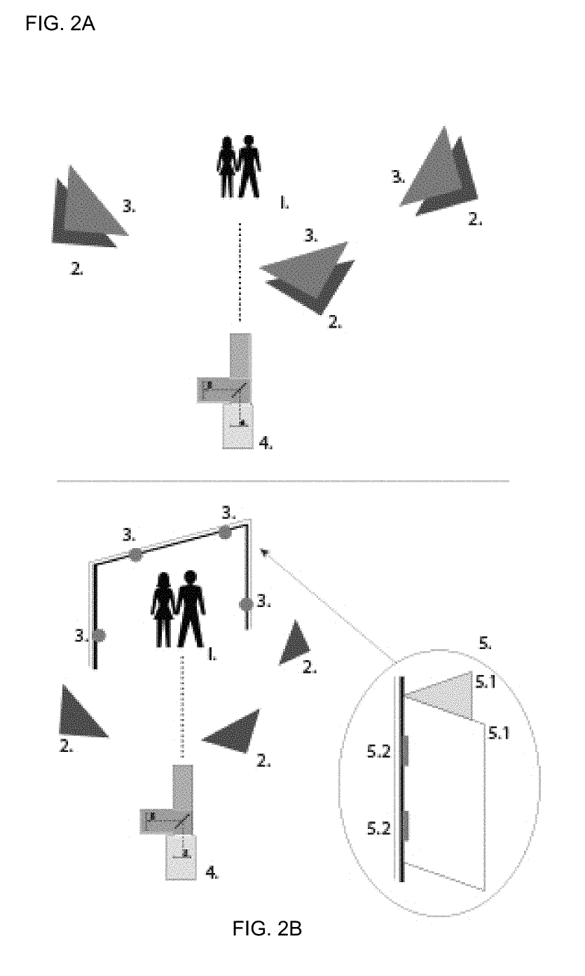

1. Foreground

2. VIS lights

3. IR lights

4. VIS camera with infrared video acquisition unit

5. IR Light ramp detail

5.1. IR Lights

5.2. Hinges

FIG. 2B illustrates a schematic diagram of an embodiment of the camera of the invention, wherein

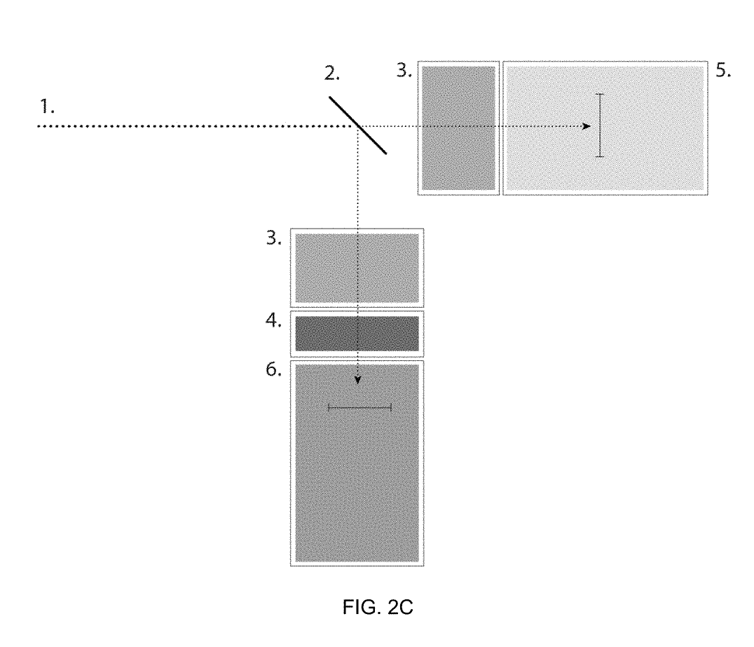

1. Light

2. Hot mirror

3. Lens

4. Narrowband filter

5. DSLR camera VIS

6. DLSR modified camera IR

FIG. 2C shows a schematic diagram of an optical system.

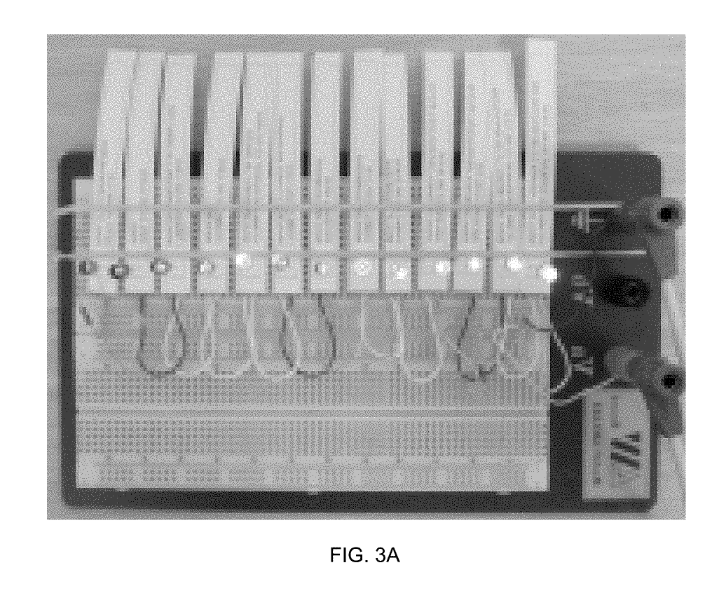

FIG. 3A and 3B illustrate the difference between VIS and IR image.

FIG. 4A illustrates image sensor sensitive used in one of the embodiment of the invention.

FIG. 4B illustrates Foveon image sensor with the addition of layers of IR used in another of the embodiment of the invention.

FIG. 5A illustrates a diagram of spectral sensitivity.

FIG. 5B illustrates a diagram of spectral sensitivity with optics.

Persons skilled in the art will appreciate that elements in the figures are illustrated for simplicity and clarity and may have not been drawn to scale. For example, the dimensions of some of the elements in the figures may be exaggerated relative to other elements to help to improve understanding of various embodiments of the present invention.

Terms and their Definitions:

Alpha Channel—black and white video channel used to determine transparency of video layers.

Chroma Keying—Current method of creation of an alpha channel based on calculation of the chroma difference between background and foreground objects. Color range of the top layer of the composite image is made transparent by software manipulation in postproduction.

Greenscreen/Bluescreen—Requirement for the chroma keying process. Uniform and evenly lit background of the scene.

VIS/NIR/IR—Specifies various wavelength ranges of light as electromagnetic radiation, where VIS stands for visible light (wavelength range 390 nm-750 nm), NIR stands for invisible near infrared light (wavelength range 750 nm-1400 nm), and IR stands for invisible infrared light (wavelength range 750 nm-1 mm).

### DETAILED DESCRIPTION OF THE INVENTION

The preferred embodiments of the present invention will now be explained with reference to the accompanying drawings. It should be understood however that the disclosed embodiments are merely exemplary of the invention, which may be embodied in various forms. The following description and drawings are not to be construed as limiting the invention and numerous specific details are described to provide a thorough understanding of the present invention, as the basis for the claims and as a basis for teaching one skilled in the art about making and/or using the invention. However in certain instances, well-known or conventional details are not described in order not to unnecessarily obscure the present invention in detail.

The invention provides for a system for highly automated and precise derivation of alpha channel in order to divide the captured scene into the foreground objects and background.

In an embodiment of the invention, the invention comprises of the following three main subsystems:

(A) Lighting sub system comprising of narrowband/monochromatic light sources in NIR (near infrared range) of light spectrum and common studio lights in VIS (visible part) of the spectrum (preferably fluorescent tubes),

(B) Electro-optical system for simultaneous acquisition of the video in VIS (color RGB video acquisition) and NIR (tuned to the same wavelength as the NIR light source using narrowband interference filter), and

(C) Video postprocessing converter optimized for generation of alpha channel from the NIR video signal in order to perform near-to-perfect determination between the foreground objects (illuminated with NIR light source) and background.

The above described system can effectively replace the common chroma-keying technique without the need of any special background on the scene e.g. blue-screen or green-screen.

The principle of the invention can be described as follows. The object is placed within the FOV (field of view) of the special camera sensitive to two part of the spectrum—NIR (near infrared range) and VIS (visible light). The camera produces two output video signals, which are available separately at the output of the system as a common color video signal for the VIS part of the spectrum and a grayscale video signal for the NIR part of the spectrum.

The object is illuminated simultaneously with the special lighting system emitting the light in the VIS and NIR parts of the spectrum. The NIR lights are narrowband and tuned to a particular wavelength. This property can be achieved preferably by an array of NIR LEDs emitting light with central wavelength for example of 850 nm and having very narrow spectrum width (full-width, half-maximum FWHM) of few nanometers. The wavelength is selected in order to reach still high sensitivity in this spectral region for common silicon based camera sensors. At the same time this wavelength is practically invisible for a human eye and also common VIS color cameras have negligible sensitivity for the same wavelength.

The LED array is formed in the way to create focused beam of the NIR light directed on the object and minimizing reflections from other objects behind. The LED array allows stepwise or continuous power level control in order to set the required dynamic range in acquired video signal and at the same time conforming hygienic limits on emitted power in the case if the object is a human being or an animal. The object is at the same time illuminated with a common VIS studio lighting system. This system should be based on fluorescent tubes to minimize emitted power in the NIR part of the spectrum. This VIS light is directed on the object to obtain desired image captured by the VIS camera. This procedure is done in a way common in the film production conforming technical and aesthetic rules. The VIS and NIR light is reflected by the object. Since the NIR light is directed only on the foreground object there are no other reflections from other objects in the scene covered in the FOV or these are negligible. The reflection of VIS light from other objects than the foreground one is allowed. The mixture of reflected light in the VIS and NIR part of the spectrum passes through the objective lens. Afterwards it enters a multispectral optical subsystem.

The multispectral subsystem consists of a relay lens to extend the optical path so that the object is projected sharply to the focal plane of both image sensors for the VIS and NIR cameras. The light beam is then divided by a prism coated for the VIS part of the spectrum with wavelengths up to 700 nm and NIR part of the spectrum with wavelengths above 700 nm. Both NIR and VIS light beams then pass again through relay lenses to have the object properly focused on the image sensors. The NIR beam is then filtered with a narrowband interference filter tuned to the same wavelength as emitted by the NIR light source, preferably 850 nm. The spectral width of the filter (full-width, half-maximum FWHM) should be the same as the width of the used NIR LEDs so that the sensitivity of the NIR camera to VIS part of the spectrum is considerably reduced. This particular alternation causes that only the objects illuminated by the beam of the NIR light source will be captured by the NIR camera, other parts of the scene in the FOV will stay considerably underexposed, which is a key characteristic for a successful mask creation. Video acquisition, at NIR and VIS run simultaneously with the same framerates and in synchronism. Due to the splitting prism there is no interference with the NIR light sources and the image of the object depends solely on the setup of the VIS light source.

The unique combination of lighting and electro-optical video capturing system introduced in this invention creates at the same time well exposed image of the object in colors and high contrast mask. Since most of the common objects including human skin and hair have high reflectivity in NIR part of the spectrum, the alpha channel obtained from the NIR camera can be used for easy decomposition of the captured color image into the foreground object (almost white level) and background (almost black). Even with optimized design of optical and electronic part of the system there are imperfections especially in the spatio-temporal alignment of the captured color VIS and NIR video sequences. The generation of a precise keying mask can be also deteriorated by a noise introduced especially at low light levels.

The another part of the system consists of a set of real time video post processing converter designed to overcome the above mentioned issues and get a masking signal from the NIR camera with a very precise spatio-temporal alignment to the VIS image.

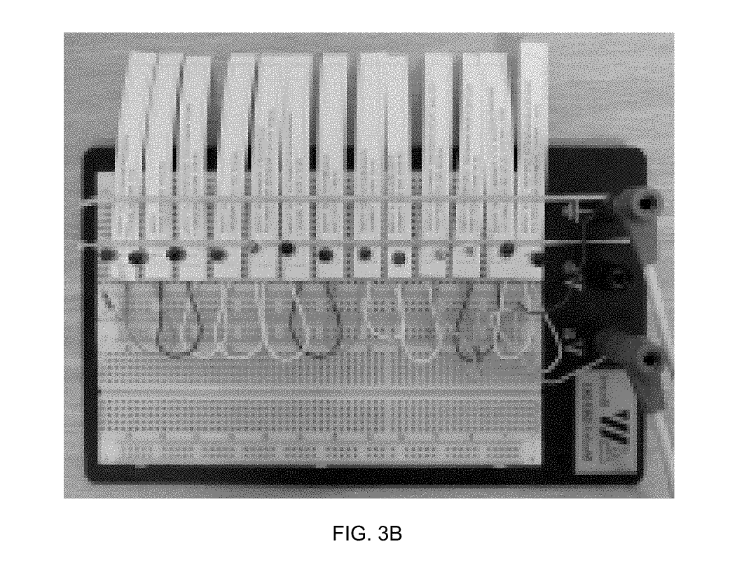

Several experiments have been conducted to test the functionality of the invention. In an embodiment of the invention it comprises of two identical DSLR (digital single lens reflex) cameras (such as Canon 550D). One of the cameras has been modified by removing the IR blocking filter to enhance its sensitivity to the invisible NIR spectra. In order to comply with a perspective of the captured scene in VIS and NIR, the two cameras must have a common optical axis. This has been achieved by using a suitable optical element that splits the incoming light to the direction of the lenses of both cameras. In order to maximize efficiency, the hot-mirror configuration for 45 degrees to the incident rays has been used. A narrowband interference filter has been placed in front of the lens of the modified NIR DSLR camera to select specific wavelength corresponding to the used NIR lighting. (FIG. 3)

In other embodiment of the invention the lighting of the scene in the NIR has been done with arrays of IR LEDs 850 nm common in surveillance systems.

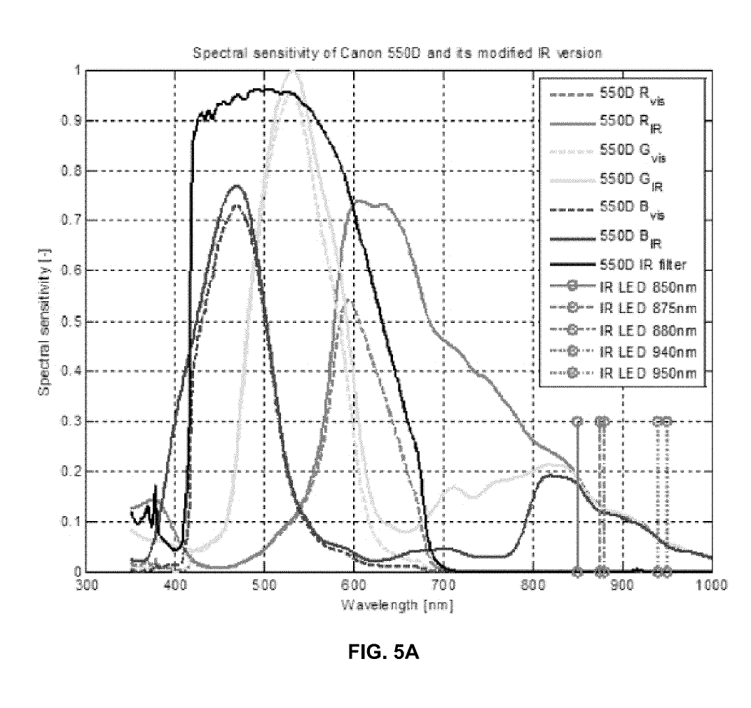

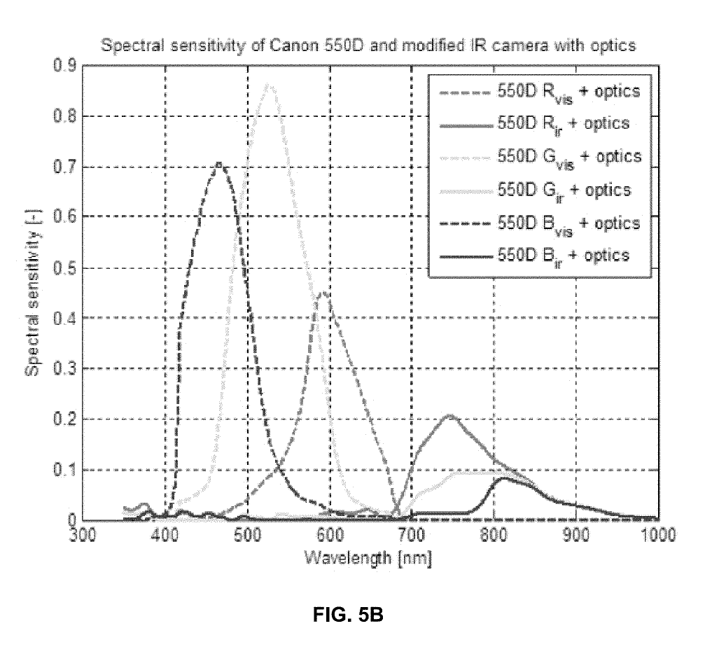

In another embodiment of the invention the detailed measurements of the spectral sensitivity of individual color channels have been carried out on a modified Canon 550D camera (with removed dust and an IR blocking filter). For comparison, a calculation was performed for the spectral sensitivity of the modified Canon 550D. Results of this measurement have been essential for selecting wavelength of LED used in the array. The measured spectral response curves are shown in FIG. 5A. Spectral sensitivity is standardized to the maximum in the green channel.

The curves labeled VIS correspond to the spectral sensitivity curves of the unaltered camera and the ones labeled as IR to a modified Canon 550D device. The VIS camera has a wavelength range 430-605 nm for a fall to 50% and 415-675 nm for a fall to 10% compared to the maximum sensitivity in the green channel. The modified device, the NIS camera, has a range of wavelengths 425-685 nm for the fall to 50% and 380-920 nm for the fall to 10% compared to the maximum sensitivity in the green channel. The measured curve clearly demonstrates the significant extension of the wavelength range of the NIR camera, especially in the red channel R. In the range of 700-820 nm there is a significant increase in sensitivity only in red channel. In the range of 820-1000 nm the sensitivity of each channel R, G and B is practically the same. These findings have been illustrated in FIG. 5A.

The plot of the spectral sensitivity of the modified NIR Canon 550D shows the corresponding spectral lines for the IR LED 850, 875, 880, 940 and 950 nm. It is obvious that a good compromise between the separation of the visible spectrum and sensitivity is at the wavelength of 850 nm. At this wavelength the spectral sensitivity in each channel is approximately equal to 20% of the peak in the green channel.

Original VIS camera reaches almost zero sensitivity at this wavelength. A possible alternative would be to use an IR LED with a wavelength between 750 and 850 nm. There is, however risk of slight interference between the sensitivity of VIS and NIR camera. Moreover the light at this wavelength the light can be seen with the human eye.

In another embodiment of the invention, to verify the suitability of individual LEDs and their respective wavelengths the test IR LED array has been constructed in the wavelength range of 850-950 nm. The LED array has been powered at the same current for all the LEDs. The array has been photographed with original VIS and modified NIR Canon 550D camera (FIG. 3).

The two images compare the result obtained in acquisition with the modified NIR and original VIS cameras. It confirms the above mentioned measurements of spectral sensitivity. All the NIR LEDs (850-950 nm) are dark in the image from the original VIS camera. In the image from the modified VIS camera it is clear that it achieves higher sensitivity for the shorter wavelength (850 nm LED Left, Right LED 950 nm).

In yet another embodiment of the invention the LED with a wavelength of 850 nm has been chosen as the most suitable based on this test. Combined spectral sensitivity of the camera Canon 550D (modified NIR and original VIS) and spectral transmission of optical components (hot-mirror filter and lens) has been calculated. The curves of the spectral sensitivity of individual color channels R, G and B are shown in the plot below. The use of optical components causes only negligible variation of the spectral sensitivity in VIS. This variation is fully covered by the white balance correction. Spectral sensitivity of the modified NIR camera is reduced by the optics. Maximum sensitivity is in the red channel for a wavelength of 750 nm. For a wavelength of 850 nm (used NIR light source) is approximately the same for all channels and reaches 6% of the maximum sensitivity, which means lower sensitivity approximately by 4 EV in NIR channel. Moreover a Zeiss narrowband interference filter has been used with a peak transmission at 850 nm in the NIR channel. The findings have been illustrated in FIG. 5B.

In yet another embodiment of the invention an array of NIR LEDs has been used. These lamps are common in surveillance applications. It is very important for these lights to verify the hygienic limits. Three lamps have been used in the particular test with angle 30 degrees, power 9 W, 96 NIR LEDs at wavelength of 850 nm.

The prototype has been used to capture test video sequences for various conditions in a film production environment. The obtained results show high performance of the prototype even with present spatiotemporal alignment errors. These errors were corrected using standard video post processing tools.

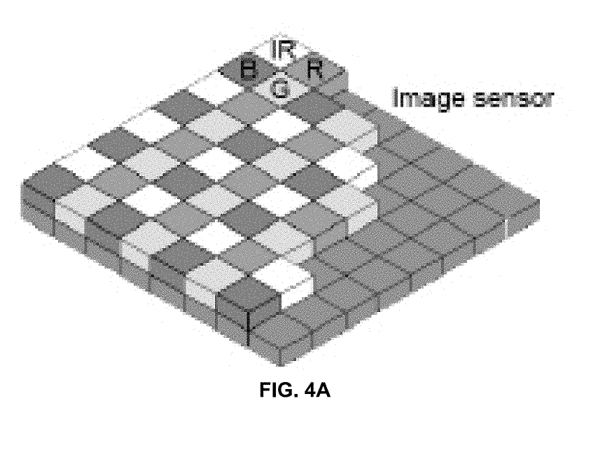

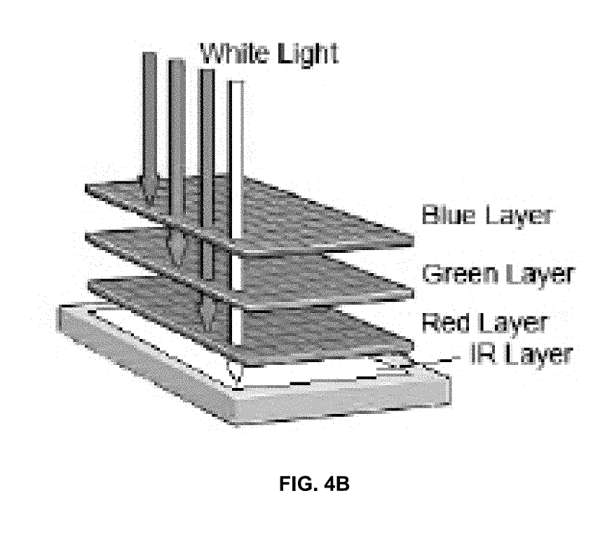

In yet another embodiment of the invention, the invention comprising of a camera with two image sensors, with a color splitting system (NIR/VIS), common RGB image sensor and image sensor sensitive to NIR light at particular wavelength (FIG. 4A). The whole image sensing system is built in one camera body. The light beam coming through the objective lens is divided by a color splitting system into VIS and NIR beams focused on two image sensors. The VIS light is captured by a common color image sensor with CFA (color filter array) with R, G, B filters. The NIR light is captured by an image sensor preferably with the same area and number of detectors as for the VIS light. There is no infrared blocking filter in the NIR channel but a narrowband NIR filter to achieve peak in the spectral sensitivity at the same wavelength as emitted by the used array of NIR LEDs. This embodiment has advantage that there is no need of relay optics.

In yet another embodiment of the invention the invention comprising of a special designed image sensor that will have CFA (color filter array) with R, G, B and IR filters for a single-sensor camera configuration or Foveon image sensor with the addition of layers of IR as illustrated in FIG. 4B). The color filters are needed because the photo sensor itself detects the light with almost no wavelength specificity, and therefore color information cannot be separated. If the CFA consisting of a mosaic of color filters is placed in front of the image sensor then the sensitivity of each particular detector on the sensor is modified by the spectral transparency of the filters in the CFA. Usually these filters are primaries Red, Green and Blue to give information about the intensity of light in red, green and blue color channel.

The full color image is then obtained from the raw date by an interpolation technique, called demosaicing. The modified CFA, where some of the R, G or B filters are changed for a narrowband NIR filter will allow a single sensor implementation of the invention. In this case, both, a color video in VIS and a grayscale video in NIR are captured by a single sensor with no need of a color splitting prism or mirror.

The present invention provides an advantage in the clarity of the resulting alpha channel and its real-time recording. It creates the alpha channel directly from the narrowband NIR light reflected by the foreground object. This solution provides near-to-perfect detail level along the edges of the object and eliminates the necessity of any sort of uniform background with chroma difference. Software manipulation is not required to calculate the chroma or contrast difference in order to create an alpha channel from VIS video layer, resulting in loss of details along the edges of the foreground object.

This gives considerable advantage both in simplified set construction and in cutting down the time required needed for image postproduction.

While the present invention is described above in connection with preferred or illustrative embodiments, these embodiments are not intended to be exhaustive or limiting of the invention. Rather, the invention is intended to cover all alternatives, modifications and equivalents included within its scope.

What is claimed is:

1. A system for capturing a scene with a simultaneous use of a near infrared (NIR) light and a visible (VIS) light to create an alpha channel mask, the system comprising:
a lighting system comprising an NIR light source and a VIS light source, wherein the NIR light source is at least one of narrowband or monochromatic, wherein the NIR light source illuminates according to a wavelength;
an electro-optical system comprising a camera that houses a first image sensor and a second image sensor such that the first image sensor and the second image sensor are operably integrated within the camera and such that the camera is configured to simultaneously acquire a video in a NIR spectrum via the first image sensor and in a VIS spectrum via the second image sensor based on the NIR light source and the VIS light source respectively, wherein the video based on the NIR spectrum is filtered with a bandpass filter tuned to the wavelength; and
a real-time post-processing converter configured to generate the alpha channel mask from the video based on the NIR spectrum in order to distinguish between a foreground object and a background over which the foreground object is positioned while avoiding a special scene background, wherein the foreground object is illuminated via the NIR light source and the alpha channel mask is generated directly from an NIR light of the NIR light source reflected by the foreground object.

2. The system of claim 1, wherein the bandpass filter is a narrowband filter.

3. The system of claim 2, wherein the narrowband filter is a narrowband interference filter.

4. The system of claim 1, wherein the real-time post-processing converter is configured to generate the alpha channel mask from the video based on the VIS spectrum.

5. The system of claim 1, wherein the VIS light source is a studio light.

6. The system of claim 1, wherein the VIS light source comprises a fluorescent tube.

7. The system of claim 1, wherein the camera is mobile.

8. The system of claim 1, wherein the electro-optical system comprises an NIR camera configured to capture based on the NIR spectrum, a VIS camera configured to capture based on the VIS spectrum, and a color splitting system, wherein the NIR camera is configured to use a bandpass interference filter to select a wavelength based on the NIR light source, wherein the bandpass interference filter is optically positioned between the color splitting system and the first image sensor, wherein the NIR camera includes the first image sensor, wherein the VIS camera includes the second image sensor, wherein the filter is the bandpass interference filter.

9. The system of claim 1, wherein the camera is equipped with a NIR/VIS color splitting system, the first image sensor that is configured to sense based on the NIR light source, and the second image sensor that is configured to sense based on the VIS light source, wherein the camera is configured to receive a light beam, wherein the NIR/VIS color splitting system is configured to split the light beam onto the first image sensor and the second image sensor such that a relay lens is not needed, wherein the bandpass filter is optically positioned between the NIR/VIS color splitting system and the first image sensor.

9. The system of claim 1, wherein the camera includes the post-processing converter.

10. The system of claim 1, wherein the bandpass filter is positioned between the first image sensor and the post-processing converter.

11. The system of claim 1, wherein the first image sensor and the second image sensor is a single image sensor comprising a color filter array with an R filter, a G filter, a B filter, and an IR filter.

12. The system of claim 11, wherein the single image sensor with the color filter is at least one of:
a color filter array with the R filter, the G filter, the B filter, and the IR filter, or
an image sensor with an addition of a layer of IR.

13. The system of claim 1, wherein the camera is configured to use at least one of a color filter array, the bandpass filter, or a hot mirror in order to split a VIS video signal formed via the second image sensor based on the VIS light source and a NIR video signal formed via the first image sensor based on the NIR light source, wherein the filter is a bandpass interference filter.

14. The system of claim 13, wherein the camera is configured to use the color filter array.

15. The system of claim 13, wherein the camera is configured to use the bandpass interference filter.

16. The system of claim 13, wherein the camera is configured to use the hot mirror.

17. A system for capturing a scene with a simultaneous use of a near infrared (NIR) light and a visible (VIS) light to create an alpha channel mask, the system comprising:
a lighting system comprising an NIR light source and a VIS light source, wherein the NIR light source is at least one of narrowband or monochromatic, wherein the NIR light source illuminates according to a wavelength;
an electro-optical system comprising a camera that includes a prism, a first image sensor, and a second image sensor such that the first image sensor and the second image sensor are operably integrated within the camera and such that the camera is configured to simultaneously acquire a video in a NIR spectrum via the first image sensor and in a VIS spectrum via the second image sensor based on the NIR light source and the VIS light source respectively, wherein the video based on the NIR spectrum is filtered with an interference filter tuned to the wavelength; and
a real-time post-processing converter configured to generate the alpha channel mask from the video based on the NIR spectrum in order to distinguish between a foreground object and a background over which the foreground object is positioned while avoiding a special scene background, wherein the foreground object is illuminated via the NIR light source and the alpha channel mask is generated directly from an NIR light of the NIR light source reflected by the foreground object, wherein the interference filter is positioned between the prism and the first image sensor, wherein the first image sensor is positioned between the interference filter and the post-processing converter.

18. The system of claim 17, wherein the camera is mobile.

19. The system of claim 17, wherein the camera includes the post-processing converter.

20. The system of claim 17, wherein the NIR light source is narrowband, wherein the wavelength is narrowband.
